(19) United States
(12) Patent Application Publication
(10) Pub. No.: US 2012/0030088 A1
(43) Pub. Date: Feb. 2, 2012

(54) SYSTEM AND METHOD FOR FACILITATING THE TRADING OF METALIZED IRON TRANSACTIONS

(75) Inventor: Joshua Hoyt, Highland Park, IL (US)

(73) Assignee: Metallic Conversion Corp., Highland Park, IL (US)

(21) Appl. No.: 13/143,925

(22) PCT Filed: Jan. 9, 2010
(86) PCT No.: PCT/US2010/020573

§ 371 Date: Oct. 18, 2011

Related U.S. Application Data
(60) Provisional application No. 61/143,716, filed on Jan. 9, 2009.
(60) Provisional application No. 61/187,261, filed on Jun. 15, 2009.

(51) Int. Cl. G06Q 40/04

(52) U.S. Cl. 705/37

(57) ABSTRACT

The disclosure presents a system and method for facilitating metalized iron transactions. The system may be implemented in a variety of ways, including as a computer readable medium for facilitating metalized iron transactions. The computer readable medium includes: logic for communicating a plurality of metalized iron transaction prompts to the remote computer for entering a plurality of corresponding metalized iron transaction parameters; logic for receiving the plurality of entered metalized iron transaction parameters in response to communicating the plurality of metalized iron transaction prompts to the remote computer; logic for determining whether the entered metalized iron transaction parameters satisfy existing market metalized iron transaction parameters; and, logic for closing a transaction for metalized iron if the entered metalized iron transaction parameters satisfy existing market metalized iron transaction parameters. The medium can also include logic for determining an adjusted price of at least one lot of metalized iron to be delivered to fulfill a metalized iron transaction utilizing an adjustment formula for calculating the adjusted price of the metalized iron transaction based on the content of at least one of the chemistry components of the at least of lot of metalized iron; logic for receiving test results of the content of at least one of the chemistry components of the at least one metalized iron lot; and logic for utilizing the test results within the adjustment formula to calculate the adjusted price.

### CROSS REFERENCE TO RELATED APPLICATIONS

This international patent application claims priority to U.S. Provisional Patent Application No. 61/143,716 filed on Jan. 9, 2009, and U.S. Provisional Patent Application No. 61/187,261 filed on Jun. 15, 2009, both which are incorporated by reference herein in their entirety.

### TECHNICAL FIELD

This invention relates generally to a system and method for facilitating pig iron commodities transactions. More particularly, the present invention relates to a system and method for allowing a first trading entity to enter into pig iron commodities transactions with a second trading entity, for buying and selling pig iron, and for entering into derivative transactions relating to the buying and selling of pig iron.

### BACKGROUND OF THE INVENTION

Steel and iron is the most widely used metallic commodity in the world. There is approximately one billion tons of annual global production capacity. Steel/iron is widely used in the manufacture of many items including but not limited to machines, such as appliances, furniture, automobiles, trucks, transportation, capital equipment and other means of production. Steel/iron is also used in construction, such as within commercial and residential structures, roads, bridges, water supply, railroads, utilities, other infrastructure. Steel/iron is also used within connectors/fasteners and structural reinforcement, as well as within consumer goods such as home and office products, recreational products. Other uses of steel/iron can also include military equipment, weaponry, armor, containers, as well as farming, agriculture, energy, exploration, extraction, refining, generation, and transmission equipment and apparatuses. Steel/iron is manufactured and used in many forms, including but not limited to sheet, coil or plate, long products such as beams (of differing shapes including I-beams and H-beams), angles, “U's”, “T's”, channels, rebar, SBQ, shapes (round, hex, square, etc.) rods, wires, rail, castings, powders, shots, balls such as ball-bearings, forgings, tubes, pipes, and hollows.

Trading systems and methods exist for many types of commodities. There are several exchanges that allow and provide for trading entities to buy and/or sell commodities on exchanges throughout the world. These commodities contracts allow those participating in the associated physical market to manage price risk and exposure. For example, there are exchange systems which provide for the trading of exchange traded contracts for energy market products ranging from various oils and petroleum based products to natural gas, to electricity. There are trading systems for agricultural products including many major crops and livestock, such as corn, wheat, soybeans, cocoa, sugar, orange juice, cattle/beef, whole hogs, pork bellies, and other commodities. Additionally, there are exchange systems which provide for the trading of exchange traded contracts for the currency market for many of the world's leading currencies, such as Dollars, Eurodollars, Euros, Sterling, Deutschemark, Australian Dollar, Yen, and others.

Further, there are exchange systems which provide for the trading of exchange traded contracts for certain metals, such as precious metals, including gold, silver, platinum, and palladium, such as base metals, including copper, aluminum, lead, nickel, tin, zinc, and even for steel, including billet (traded on the LME) and hot rolled band (traded on the Nymex/Comex).

Futures contracts and systems for the trading of futures contracts generally have the objective of managing price risk for market participants, including those involved in the supply chain, such as users, producers, and consumers. There are also financial participants (non-market) who use futures contracts and systems for the trading of futures contracts to speculate, to express an opinion about price, or to use such systems as a tool to augment profit, or reduce risk in other arenas in which they have a position. However, the present trading systems and markets have not recognized these advantages in the context of Pig Iron, and the exchange traded steel contracts and systems currently offered by the LME and Comex/Nymex are significantly deficient in this regard, and only allow for end output steel products (billet/hot rolled band) to be traded.

The current systems for the trading of futures contracts for the steel industry are not well accepted. As mentioned, the current contracts that exist are for billet on the LME and for rebar on a middle-eastern exchange. The Comex division of Nymex has initiated a contract/system for the trading of hotband. All of these systems for the trading of futures contracts are inherently flawed. Specifically, the hotband and other finished/semifinished product contract trading systems are for products which have specific end market requirements, including specific sizes, specific chemistries, and other specific end market parameters. In addition, these products are used and produced over a widely dispersed geographic area (global), making delivery difficult and expensive, and therefore parameters for trading more complicated and less efficient. The end market products traded within these existing trading systems are also delicate and can easily be damaged in handling, are prone to “spoilage” (the products can age harden and the value can degrade while sitting in storage, creating a preference for newer material over older material), and may differ in quality due to different producers using different methods of production, which will lead to physical differences of one product over another for the same set of contract or transaction parameters. The billet contract trading systems are used for trading “bar” products only (usually rebar). Thus, the billet contract trading systems are inherently very limited in nature. In addition, not all rebar makers produce from billet, or the same specifications of billet, causing billet to be only a terminal product for a small percentage of steel users.

Steel makers do not perceive their product as a commodity. Specifically, steel makers have varied manufacturing techniques, equipment, and product capabilities. They will also have different fixed costs and variable costs. They will also use different raw materials. Thus, the end market products may have different physical properties, such as grain structure, or surface quality that would not be adequately captured/differentiated by the trading systems for such futures contracts. Steel producers perceive their product as a highly engineered solution, in many ways distinct from that produced by their peers. The end market steel producers can be considered highly specialized producers, causing their end market products to not be “commodities” in the true sense of this exchange traded category, as there can be substantial differences and qualities from one producer to another. In addition, end product steel makers perceive that a trading systems for such end product contracts encourages the commoditization of their product. This will compromise their pricing power making them less likely to become participants in such markets. Further, a trading system for a nondeliverable contract is unappealing to the end product steel producers for a number of reasons including the inability for any supply-chain participant to use it to manage disruptions in business and seasonalities. There is also a suspicion that being undeliverable will make it susceptible to manipulation by non steel industry participants that can't be mitigated through the delivery mechanism. Furthermore, due to steel production and consumption points being widely and unevenly distributed globally, liability for damage in handling, and warehousing for a finished steel product is significant. Logistics costs to and from delivery points may be cost prohibitive as well.

Despite the advances in the field, the industry is in need of systems and methods for facilitating the trading of pig iron transactions or contracts.

### SUMMARY OF THE INVENTION

This present invention is directed to a system and method for facilitating the trading of an exchange traded pig iron contract for the steel industry that is vastly superior to existing systems. This present invention eliminates the fundamental flaws of the other exchange traded steel contract trading systems while defining a market for contained iron units on an end-product neutral basis. The system and method for facilitating the trading of an exchange traded pig iron transaction allows for the trading of contracts for raw material input.

This invention addresses the particular dynamics of the steel industry on several levels, including culturally, pragmatically (implementability, logistics, universality), and the need/usefulness to the industry participants, including buyers and sellers. As such, several different industry participants will benefit from this invention.

There are two general methods for producing steel products: 1) integrated steel making; and 2) EAF (electric arc furnace) steel making. Each of these types of steel making has distinct characteristics, advantages and disadvantages. Specifically, an electric arc furnace operation can be placed anywhere there is adequate (affordable) electric power available and access to scrap or scrap substitutes, and the other raw materials EAF's need to make the type steel the mill is designed to produce. EAF operations are significantly less capital intensive to build than integrated mills. EAFs are also operationally scalable in terms of matching production with demand. A steel mill which uses the integrated steel making process, while more expensive to construct, uses iron ore as its main raw material, and therefore is not dependant on scrap or inexpensive electricity. Such a mill and process can be scaled larger. A coal fired process is used, which is not dependant on electricity or the price of electricity. The output product from such a mill is typically more easily controlled as well since the feedstock/raw material going in is a mined product and is therefore more chemically uniform than scrap metal used in EAF steel making. However, production cannot be scaled as widely as in an EAF (electric arc furnace). Integrated steel making furnaces become increasingly inefficient as the operating production is reduced further and further below capacity. An integrated steel making furnace cannot be operated efficiently at less than 70% of capacity. An EAF can. When an integrated mill makes steel, the process starts with iron ore. The process then heats up the iron ore in a reducing atmosphere. The reducing atmosphere reduces the iron ore to “metalized” molten iron. At this point in the production cycle, the integrated mill will mix the molten iron with other steel making alloying agents and additives, through several distinct and varying (depending on the steel product the mill is outputting) manufacturing steps to produce a finished steel product.

Some non-mill operations have their own captive iron ore or have ready access to iron ore. These types of operations perform the initial integrated steel making operation, which “metalizes” the iron ore, but they do not make a finished steel product. These operations make an intermediate product called “pig iron.” Pig iron producers smelt iron ore in blast furnaces to reduce the iron ore to molten iron. The steel making process is then interrupted. Instead of alloying, casting, or performing some other additional finishing process, pig iron producers take the molten iron and pour it into molds where the material solidifies. The solidified material is dumped out and accumulated for sale as a merchant product for remelt only, called “pig iron.”

Pig iron is a raw material used by steel mills as a substitute for high-grade scrap metal. High grade scrap can include stampings, busheling, auto bundles, and other scrap products, which are sometimes called “prompt industrial scrap”. Pig Iron is a superior product to scrap for several reasons. First, pig iron has a more uniform chemistry and higher purity than scrap, as it is a manufactured product from a uniform ore body. Second, pig iron has a higher recovery than scrap due to its geometric form. Third, use of pig iron instead of scrap will help furnaces achieve higher throughputs due to reduced surface area and higher density. As such, and for other reasons, many foundries and mills use pig iron as an important raw material, displacing some or all of their scrap, to control variations in chemistry, to allow the use of less expensive and lower grade scrap in the charge recipe, and/or to achieve higher productivity. These foundries and mills also choose pig iron over common grades of scrap that are sold in the market place because such scrap does not have specifications that are universally agreed upon by individual consumers. The wide variances in scrap specifications exist because at each plant; specific equipment, configuration and product tolerances can vary significantly. As an exchange tradable product, pig iron is preferable to scrap because it has uniformity that scrap lacks. Pig iron's uniquely homogenous chemistries and geometry make it uniquely well suited to being the base exchange traded product that is used both to hedge the value of, and as the benchmark for, establishing the values of other iron containing raw materials like scrap.

The United States is the largest market in the world for merchant pig iron, at least for now. Most merchant pig iron consumed in the United States, regardless of where it originates or is eventually consumed, physically is shipped through the Port Of New Orleans (NOLA). This creates a natural delivery point/warehouse location for pig iron delivered against an exchange traded pig iron contract. In addition, pig iron is easy and cheap to store. Pig iron will not degrade markedly over time. Pig iron is also not subject to handling damage like other materials, which are the subject of steel traded contracts, as explained above herein. Interestingly, it really does not matter if pig iron is dropped, has some broken pieces, or is old. Pig iron moves in bulk and can be offloaded from ships at rates in excess of 10,000 tons per day.

Because a pig iron contract captures only the contained metallic iron unit value delivered to a certain location, steel producers do not lose their pricing power over their finished product. Neither a steel-maker's production capacity, specific value add capabilities, nor the specific market dynamics for the steel-maker's end product are contained in a pig iron contract. Steel-makers retain their full ability to make production, sales and market segmentation decisions, and retain pricing power for their highly engineered products. However, the present system for facilitating pig iron transactions captures the value of the contained iron, not the value of production capacity within the steel industry. Additionally this does not compromise a consumer's ability to segment their value for different iron containing inputs (from various scrap grades etc.). This would prevent any threats to steel mills, which is a significant advantage over other traded steel contracts.

The present system for facilitating pig iron transactions allows market participants along the entire steel production and supply chain to mitigate risk in the contained/underlying metallic value of numerous steel products. Steel producers would not lose their ability to negotiate the value add for their particular products. Additionally, the present system opens up the possible number of industry users of pig iron contracts to include electric arc furnace steel mills, pig iron producers, as well as scrap dealers (as they sell a product which is a substitute for pig iron). In particular, scrap dealers may be interested in using the present system. Specifically, most scrap iron can be viewed broadly as an “iron unit”. A specific scrap stream's specific characteristics will determine its value in the market against a benchmark “iron unit”. Pig iron is a good product to serve as that benchmark against which all iron containing raw materials can be “benchmarked” for value. The iron ore industry can back out the percentage of iron contained in a body of ore and the “treatment and refining charges” that define the cost of converting from ore to pig iron (or at an integrated mill through the pig iron stage to a finished product) to arrive at a price for the iron units. Thus, iron ore producers, traders and indeed integrated mills can use the present system for facilitating pig iron transactions to hedge pricing risk for iron ore.

As such, the system and method of the present invention is directed to facilitating pig iron transactions. The system and method may be implemented in a variety of ways, including as a computer readable medium for facilitating pig iron transactions. In one embodiment, the computer readable medium includes: logic for communicating a plurality of pig iron transaction prompts to the remote computer for entering a plurality of corresponding pig iron transaction parameters; logic for receiving the plurality of entered pig iron transaction parameters in response to communicating the plurality of pig iron transaction prompts to the remote computer; logic for determining whether the entered pig iron transaction parameters satisfy existing market pig iron transaction parameters; and, logic for closing a transaction for pig iron if the entered pig iron transaction parameters satisfy existing market pig iron transaction parameters.

In a further embodiment, the system includes a computer memory receiving and storing a first pig iron market offer to sell and a second pig iron market offer to buy, received from respective first and second transacting parties. Each of the first and second market offers have at least one parameter associated therewith. The system further includes a processor for receiving the first and second pig iron market offers and respectively at least one parameter associated therewith. The processor is also provided for determining whether the first and second pig iron market offers stored in the computer memory match with one another, by at least determining whether the respective at least one parameter for each of the first and second pig iron market offers match. The processor is further provided for concluding a pig iron transaction when the first and second pig iron market offers match.

Other systems, methods, features, and advantages of the present invention will be, or will become, apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a graphical representation of a computer-based pig iron commodity transaction system.

FIG. 2 is a block diagram of one form of the pig iron commodity transaction system of FIG. 1.

FIG. 3 is a block diagram of one form of a computer or server of FIG. 1 and/or FIG. 2, having a memory element with a computer readable medium for implementing the pig iron commodity transaction system.

FIG. 4A is a flowchart showing an exemplar embodiment of the pig iron commodity transaction facilitator of FIG. 3.

FIG. 4B is a continuation of the flowchart of FIG. 4A.

FIG. 4C is a continuation of the flowchart of FIG. 4B.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention provides individuals or entities the ability to enter into pig iron commodity transactions over/through an exchange platform or open market. Specifically, entities which could not previously enter into transactions over/through an open market or exchange platform to buy and/or sell pig iron, now have the ability to do so by using the system described herein for facilitating the trading of pig iron, cash contracts, futures, options or derivatives thereof. Entities wishing to enter into such a pig iron transaction can be considered as transacting parties. Having enough parties which want to enter into pig iron transactions from both a buy side and a sell side creates “liquidity. Some examples of transacting parties include, but are not limited to, producing entities, such as pig iron producers, iron ore miners, steel mills, foundries, as well as non-producing entities, such as service centers/distributors and downstream manufacturers of goods, which do not have direct contact with pig iron but use steel or other materials which contain Pig Iron and/or substitute iron units (i.e. scrap steel). Investors, speculators and financial participants are also examples of prospective transacting parties.

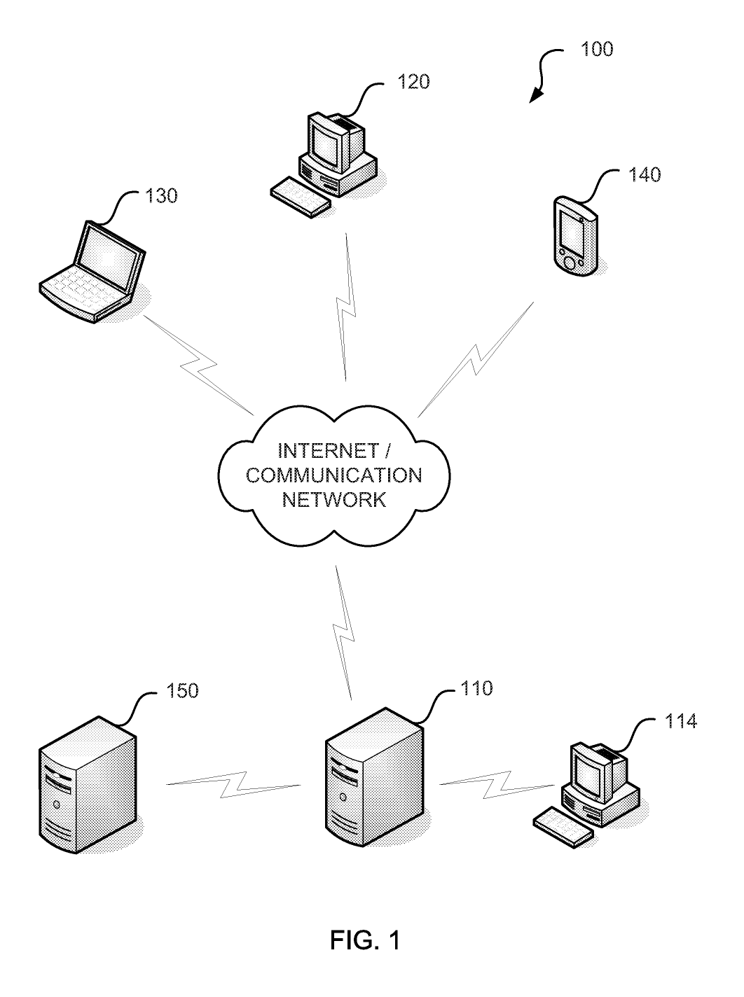

FIG. 1 is a graphical representation of a computer based or implemented system for facilitating the trading pig iron transactions 100. The system includes a plurality of transacting party remote computers 120, 130, 140, such as client computers, which are connected to and in communication with a network, such as the Internet or other computer network, a manner which is known in the art and which will be better understood from the below description. These remote computers 120, 130, 140 each can run an interface program, such as an Internet browser application, for connecting to the Internet/network, capable of communicating with a central pig iron trading facilitator application or system, which can be server-based. Specifically, for communicating with the transacting party remote computers 120, 130, 140, a central pig iron transaction facilitator computer 110 is connected to and in communication with a network, such as the Internet, in a manner which is known in the art. Firewall and other security systems and applications (not shown) may be used to prevent and deter unauthorized access to the pig iron transaction facilitator computer 110, as is known in the computer networking art.

For the pig iron transaction facilitator computer 110 and the pig iron transaction facilitator application or system therein, as will be described in more detail below, a pig iron market administration client computer 114 may be connected to and may be placed in communication with the pig iron transaction facilitator computer 110 for interfacing with the pig iron transaction facilitator computer 110 to provide installation, set-up, and/or ongoing maintenance interface functions. The pig iron transaction facilitator computer 110 may also be connected to and be in communication with one or more third party computers or servers. One example of a third party computer 150 is another public market computer which can provide various real time market information about other publicly traded securities, commodities, and other public market information. Another example of a third party computer 150 is an transacting party financial information verification information computer which can provide various real time financial and credit information about one or more of the transacting parties for verifying that a transacting party qualifies for one or more transactions attempted to be entered into by the transacting party. As will be explained below, this third party computer 150 can also include accounts for and information about the transacting parties, can include a clearinghouse for the trading of pig iron, and/or can include guarantee mechanisms for the pig iron trading. These various functions can alternatively be included directly within the pig iron transaction facilitator computer 110 and/or separated out into various computers which may or may not be controlled by third parties.

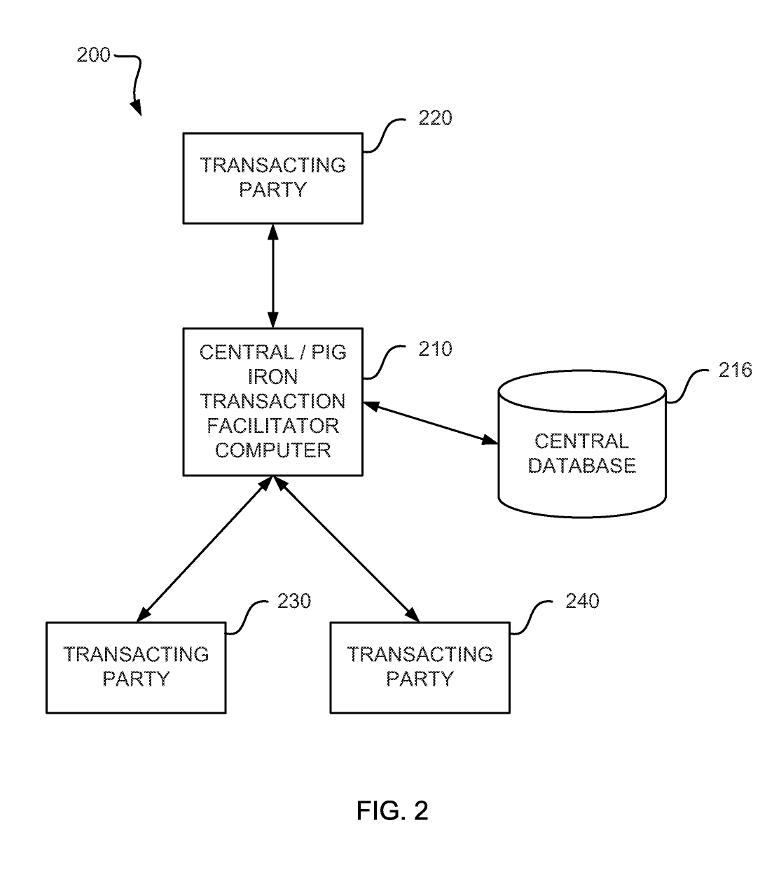

FIG. 2 is a block diagram of a computer based or implemented system for facilitating trading pig iron transactions 200 which can be implemented within the computer based or implemented system for facilitating the trading pig iron transactions 100 of FIG. 1. Specifically, each of the remote/client computers 120, 130, 140 of FIG. 1 can perform and function as either buying transacting party remote/client computer 220, or selling transacting party remote/client computer 230, 240, or both. The buying transacting party remote computer 220 block of FIG. 2 may also represent a set of interface screens and functionality for performing all of the buying functions provided by the pig iron transaction facilitator computer 210, which is connected to and in communication with the buying transacting party remote computer 220. Likewise, the selling transacting party remote/client computers 230, 240 blocks of FIG. 2 may also represent a set of interface screens and functionality for performing all of the selling functions provided by the pig iron transaction facilitator computer 210, which is connected to and in communication with the selling transacting party remote/client computers 230, 240. Further, the pig iron transaction facilitator computer 210 block of FIG. 2 can also represent various sets of interface screens and functionality for performing all of the functions provided by the pig iron transaction facilitator computer 210, which is connected to and in communication with a central pig iron market database 216 residing within a memory.

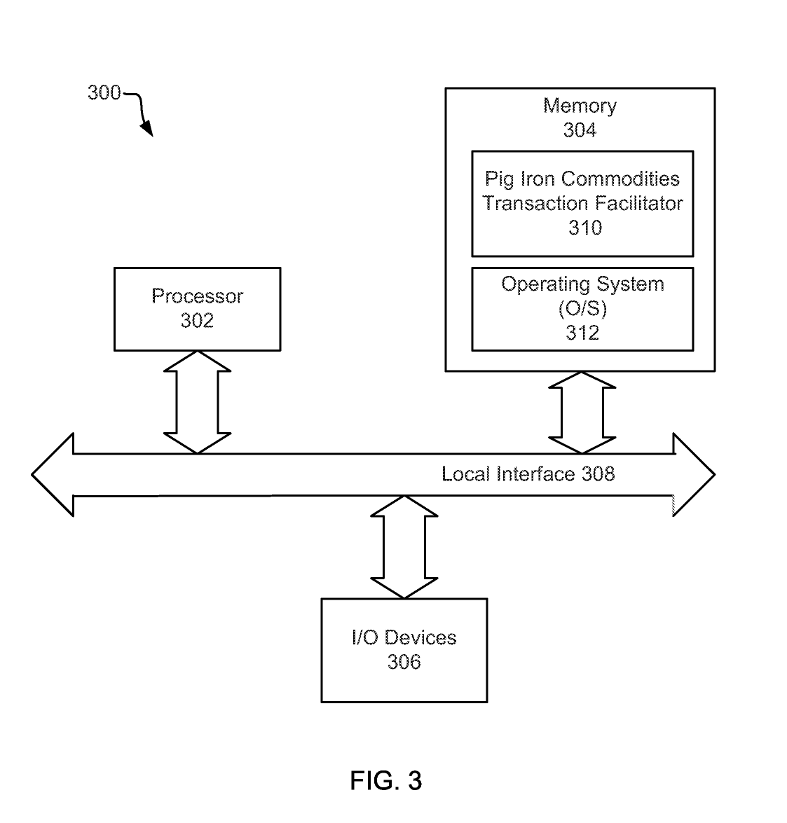

FIG. 3 is a block diagram of a computer 300. The computer 300 may be the pig iron transaction facilitator computer 110 of FIG. 1 and/or the pig iron transaction facilitator computer 210 of FIG. 2. The computer 300 may include a memory element 304. The memory element 304 may include a computer readable medium for implementing the system and method for allowing a first trading entity to enter into pig iron commodities transactions with a second trading entity, or for facilitating a pig iron commodities transaction.

The pig iron commodities transaction facilitator system 310 may be implemented in software, firmware, hardware, or any combination thereof. For example, in one mode, the pig iron commodities transaction facilitator system 310 is implemented in software, as an executable program, and is executed by one or more special or general purpose digital computer(s), such as a personal computer (PC; IBM-compatible, Apple-compatible, or otherwise), personal digital assistant, workstation, minicomputer, mainframe computer, computer network, “virtual network” or “internet cloud computing facility”. Therefore, computer 300 may be representative of any computer in which the pig iron commodities transaction facilitator system 310 resides or partially resides.

Generally, in terms of hardware architecture, as shown in FIG. 3, the computer 300 includes a processor 302, memory 304, and one or more input and/or output (I/O) devices 306 (or peripherals) that are communicatively coupled via a local interface 308. The local interface 308 may be, for example, but is not limited to, one or more buses or other wired or wireless connections, as is known in the art. The local interface 308 may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor 302 is a hardware device for executing software, particularly software stored in memory 304. Processor 302 can be any custom made or commercially available processor, a central processing unit (CPU), an auxiliary processor among several processors associated with the computer 300, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. Processor 302 may also represent a distributed processing architecture such as, but not limited to, SQL, Smalltalk, APL, KLisp, Snobol, Developer 200, MUMPS/Magic.

Memory 304 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 304 may incorporate electronic, magnetic, optical, and/or other types of storage media. Memory 304 can have a distributed architecture where various components are situated remote from one another, but are still accessed by processor 302.

The software in memory 304 may include one or more separate programs. The separate programs comprise ordered listings of executable instructions for implementing logical functions. In the example of FIG. 3, the software in memory 304 includes the pig iron commodities transaction facilitator system 310 in accordance with the present invention, a suitable operating system (O/S) 312. A non-exhaustive list of examples of suitable commercially available operating systems 312 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system 312 essentially controls the execution of other computer programs, such as the pig iron commodities transaction facilitator system 310, and provides scheduling, input-output control, file and data management, memory management, and communication control and related services.

The pig iron commodities transaction facilitator system 310 may be a source program, executable program (object code), script, or any other entity comprising a set of instructions to be performed. When a “source” program, the program needs to be translated via a compiler, assembler, interpreter, or the like, which may or may not be included within the memory 304, so as to operate properly in connection with the O/S 312. Furthermore, the pig iron commodities transaction facilitator system 310 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, .Net, HTML, and Ada. In one embodiment, the pig iron commodities transaction facilitator system 310 is written in Java.

The I/O devices 306 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices 306 may also include output devices, for example but not limited to, output modules for PLCs, a printer, bar code printers, displays, etc. Finally, the I/O devices 306 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

If the computer 300 is a PC, workstation, PDA, or the like, the software in the memory 304 may further include a basic input output system (BIOS) (not shown in FIG. 3). The BIOS is a set of essential software routines that initialize and test hardware at startup, start the O/S 312, and support the transfer of data among the hardware devices. The BIOS is stored in ROM so that the BIOS can be executed when computer 300 is activated.

When computer 300 is in operation, processor 302 is configured to execute software stored within memory 304, to communicate data to and from memory 304, and to generally control operations of computer 300 pursuant to the software. The pig iron commodities transaction facilitator system 310, and the O/S 312, in whole or in part, but typically the latter, may be read by processor 302, buffered within the processor 302, and then executed.

When the pig iron commodities transaction facilitator system 310 is implemented in software, as is shown in FIG. 3, it should be noted that the pig iron commodities transaction facilitator system 310 can be stored on any computer readable medium for use by or in connection with any computer related system or method, although in one preferred embodiment, the pig iron commodities transaction facilitator system 310 is implemented in a centralized application service provider arrangement. In the context of this document, a computer readable medium is an electronic, magnetic, optical, or other physical device or means that can contain or store a computer program for use by or in connection with a computer related system or method. The pig iron commodities transaction facilitator system 310 can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the pig iron commodities transaction facilitator system 310 is implemented in hardware, the pig iron commodities transaction facilitator system 310 may also be implemented with any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

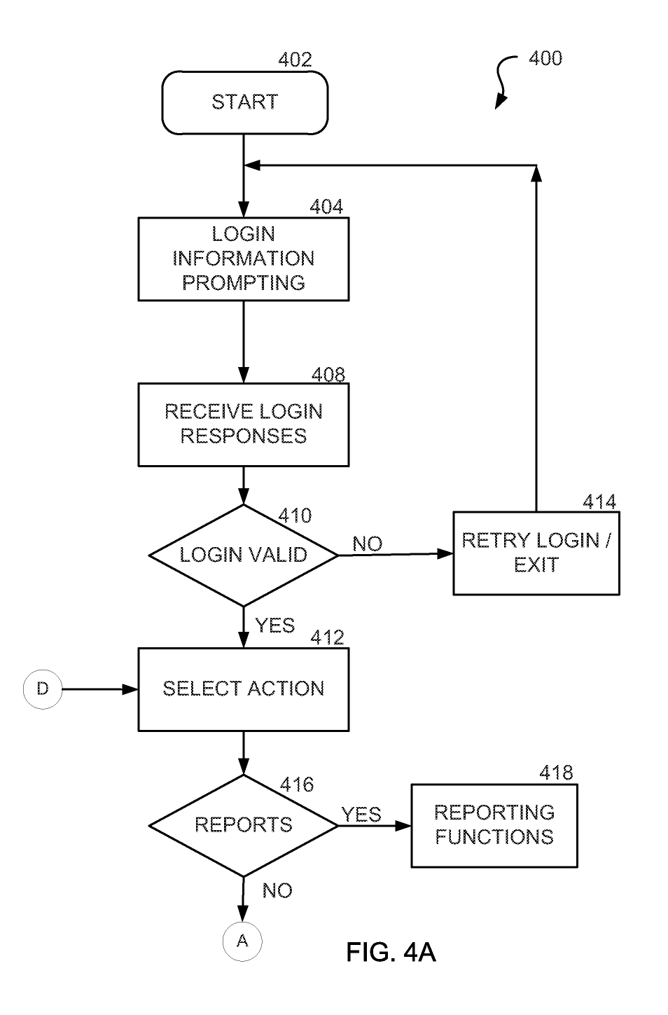

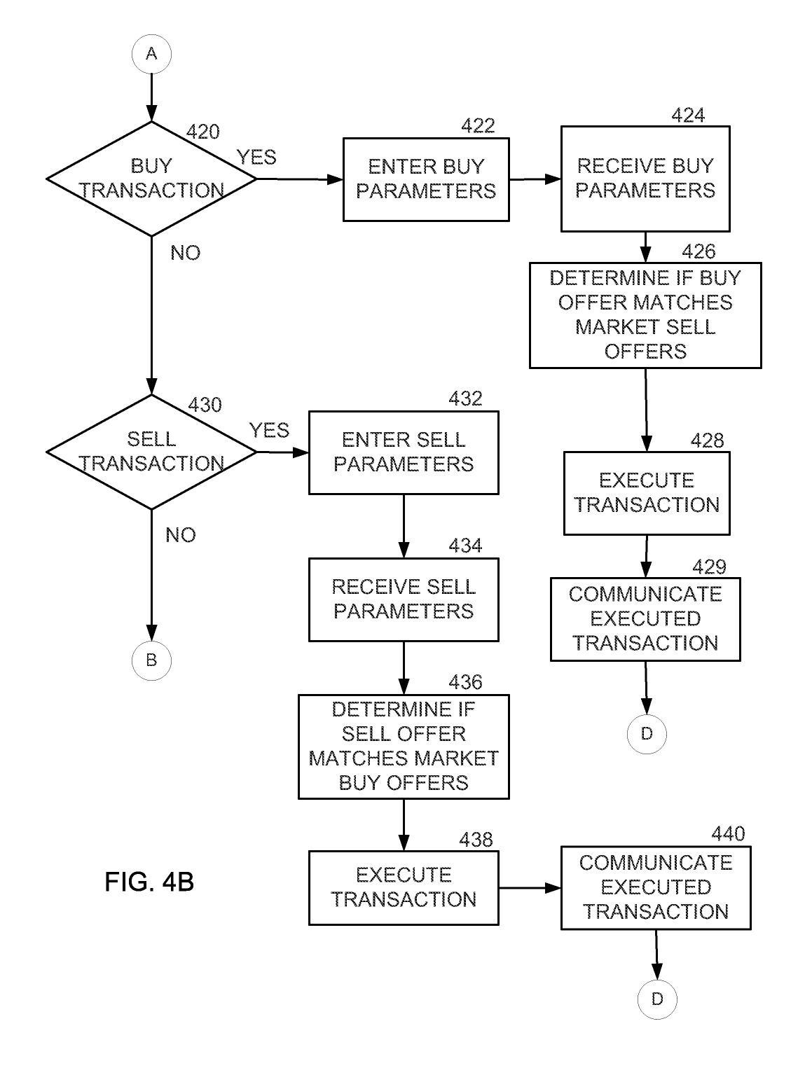

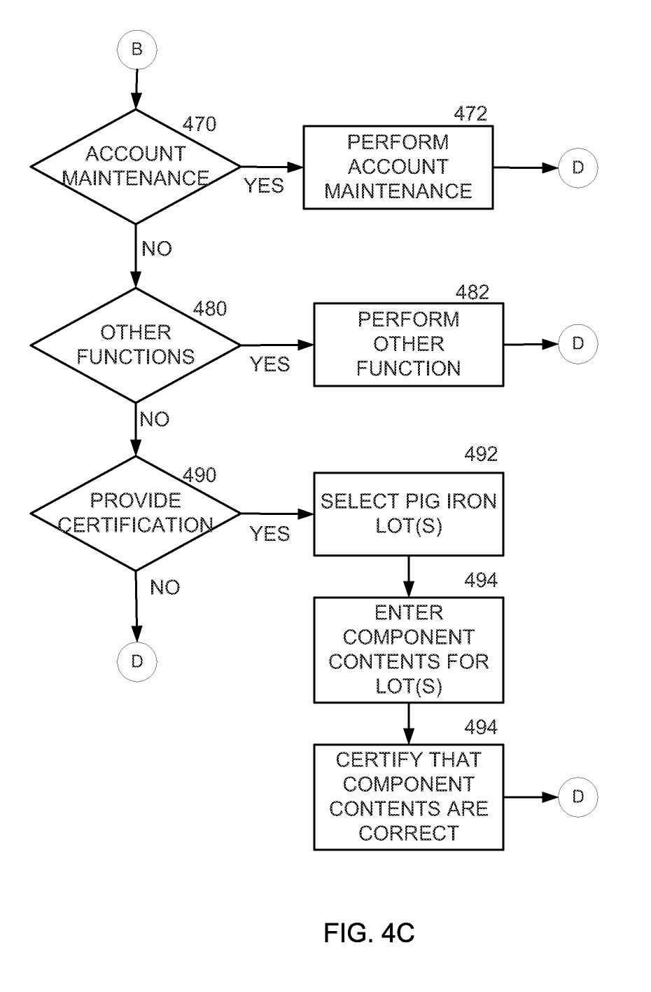

FIG. 4A-4C is a flowchart showing a first exemplary embodiment of the pig iron commodities transaction facilitator system 310 of FIG. 3, shown as blocks within FIGS. 4A-4C, which can be considered as the facilitator system 400 as well or in the alternative. In block 402, the processor calls or triggers the facilitator system 210, 310, 400. After block 402, the facilitator system 210, 310, 400 moves to block 404. In block 404, facilitator system 210, 310, 400 communicates to a remote/client computer from the central computer a plurality of sign-in prompts. The sign-in prompts can be for a user without designation of any originator, respondent, or other type of user. In fact, most users of the system 210, 310, 400 will be able to perform both buying and selling functions for the buying and/or selling of pig iron commodities (and derivatives thereof), using the same user account. Prompts, such as user ID and password prompts, may be sent to the user at the remote/client computer for this purpose.

After block 404, the facilitator system 210, 310, 400 moves to block 408. At block 408, the system 210, 310, 400 has logic for receiving sign-in or login responses from the remote/client computer at the central computer. The central database will have stored therein user account information including a username and login ID, as well as a company name, address, phone number, email contact information, financial account information relating to the user for executing transactions, and other information which identifies the user and which is associated with the user for implementing transactions. After block 408, the facilitator system 210, 310, 400 moves to block 410. At block 410, the system 210, 310, 400 has logic for determining whether a user, such as an originator is associated with the sign-in or login responses. At block 414, if the user login information does not match login information stored in the central database, the user is not granted access to the system 210, 310, 400 and can try to log into the system again. The system 210, 310, 400 also has logic for verifying whether the originator associated with the sign-in responses should be granted access to functions of the system 210, 310, 400. In one embodiment, the user is only allowed a predetermined number of unsuccessful attempts to log into the system 210, 310, 400 before the user and respective client computer is locked out from further attempts at logging into the system 210, 310, 400 running on the central computer or server. Once the user gains access to the system, some of the functions of the system available to a user include buying pig iron (see block 420) and selling pig iron (see block 430), each of which can include pig iron derivative transactions. At block 412, the system 210, 310, 400 has logic for transmitting to the user interface selections for allowing the user to select such available functions of the system, as indicated. Other functions are available within the system 210, 310, 400, as are described in greater detail herein.

The system 210, 310, 400 and logic therein generally uses an auction model wherein a potential buyer bids a specific price for pig iron as a commodity and a potential seller asks a specific price for the pig iron, which usually means that the buy side or sell side will accept any ask price or bid price for the pig iron, respectively. When the bid and ask prices match, a sale takes place on a first come first served basis if there are multiple bidders or askers at a given price, or according to a procedure established by an exchange or clearing firm, such as SOES (Small Order Entry System) that augments fairness, or some other value supported by an exchange or clearing house. However, in certain embodiments, the present system 210, 310, 400 and logic further allows for pig iron trading parameters to be set by the potential buyer and/or selling. Specifically, in the context of derivatives, such as forwards, futures, options, and/or swaps, certain pig iron contract trading parameters set forth herein can be used within the trading process.

As such, in one embodiment, the present system 210, 310, 400 is provided to facilitate pig iron futures contract trading. The system 210, 310, 400 allows for the establishment of a sales price for a futures contract for a pig iron commodity, the determination of the present value of the futures contract, and the sale of the pig iron futures contract to a transacting party who desires to acquire the pig iron futures contract at the present time for use, purchase, or sale in the future. A pig iron market index can be determined by determining the present value of a pig iron futures contract, which can then be used to facilitate trading of the pig iron futures contracts. The pig iron market index can be calculated in various country denominated currency values, such as in Dollars or Euros.

In one embodiment, a trading entity computer system within the overall system can have secure Internet access for use by the transacting parties. The transacting parties can access publically available pig iron market information through the present facilitator system 210, 310, 400. The trading entity computer system is in communication with or is integral with the trading computer(s), and other financial systems, such as guarantee financial computer systems and clearing computer systems, which may be needed to facilitate pig iron trading. The present system 210, 310, 400 is provided for hosting pig iron market trading, and provides trading entities with a centralized mechanism that facilitates trading. The trading system(s), such as the facilitator system 210, 310, 400, are in communication or integral with the trading entity computer system to obtain and communicate information, such as account information and trading records. The trading system can also communicate with or is integral with clearing computer systems in executing the pig iron trades of the trading entities using the trading or facilitator system 210, 310, 400.

Thus, in one embodiment, FIGS. 4A-4C generally show some of the selections available to a trading entity user through the facilitator system 210, 310, 400 system, as shown with reference to at least blocks 420 and 430, and related blocks. Thus, beginning at block 402, the system 210, 310, 400 provides the user with the ability to select login functions, reporting transaction functions, account maintenance functions, and other functions. As such, the system 210, 310, 400 includes logic at block 402 for gaining access to transaction interfaces and functions. The system 210, 310, 400 also include logic beginning at blocks 420 and 430 for providing to the user a plurality of transaction interface screens and prompts to the remote/client computer of the user from the central computer, for performing pig iron transactions. Thus, if the user would like to perform a pig iron market transaction(s), the user can select market transaction functions provided through one or more interface screens at the remote/client computer from the central computer, as generally indicated at block 420 and 420. The system 210, 310, 400 can provide the plurality of market transaction interface screens prompts to the remote/client computer of the user from the central computer, for entering into pig iron market transactions.

Specifically, the system 210, 310, 400 logic at blocks 422 and 432, through one or more interface screens provided to the user through a remote/client computer, prompts the user to enter various information needed and/or useful to entering into a pig iron market transaction, as will be described in greater detail in the context of one preferred embodiment herein below. The system 210, 310, 400 central computer can receive from the user through the client computer the type of trade that the user wishes to enter into, such as a market offer to buy (422) or market offer to sell (432) pig iron, or a forward, a future, and option, or a swap transaction type. For example, this logic is configured to communicate a plurality of futures contract prompts from the central computer to the remote/client computer for entering pig iron futures contract information into the system which is then used by the system to establish a pig iron futures contract with another transacting entity. As such, the system 210, 310, 400 prompts the transacting entity users to enter, and receives and stores, pig iron market offers. The market offers have parameters associated with each market offer, which the transacting entity can enter through the interface screens provided through the client computer, as indicated at blocks 422 and 432, which are then received and stored within the system 210, 310, 400, as indicated at blocks 424 and 434. Specifically, the interface screens can be configured to allow the transacting entities to enter and the system 210, 310, 400 can be configured to store and utilize the size of each piece of pig iron in a lot, chemistry specifications for the pig iron, delivery location for the pig iron, contract size, delivery expiration, and price. With respect to the size of each piece in a lot, in one embodiment, the size can range from 2 to 12 kilograms per piece in the lot. With respect to chemistry specifications for the pig iron, in one embodiment, the chemistry specifications can include the carbon content of the pig iron, the silicon content of the pig iron, the sulfur content of the pig iron, the phosphorus content of the pig iron, the manganese content of the pig iron, and the iron content of the pig iron, each usually stated in percentages of the overall composition of the pig iron.

In one embodiment, the system 210, 310, 400 can be configured to inform users about certain aspects of the pig iron that is being traded. In particular, the system 210, 310, 400 can be configured to store in memory one or more predetermined acceptable carbon content levels and/or other parameters, such as predetermined minimum/maximum acceptable carbon content levels and/or other parameters. Upon request from the user, the system 210, 310, 400 can inform users about the minimum/maximum and/or actual carbon content levels and/or other parameters of the pig iron that is to be traded and/or has been traded, respectively, by trading entities through the interface screens, and in particular the predetermined entered minimum/maximum carbon content levels and/or actual carbon content levels of the pig iron that has been traded, and/or other minimum/maximum and/or actual predetermined parameters stored within memory within the system 210, 310, 400. For example, the system 210, 310, 400 can be configured to inform users of the brand of the pig iron as well as the origin of the pig iron. In addition, the system 210, 310, 400 can be configured to inform users that the carbon content of the pig iron is in the range of 3.5 to 4.5%, that the silicon content is 1.0% or less, that the sulfur content is 0.05% or less, that the phosphorus content is 0.1% or less, that the manganese content is 1.2% or less, and/or that the iron content is at least 94.5%. The interface screens can also be configured to allow the transacting entities to view and the system 210, 310, 400 can be configured to store and utilize the delivery location for the pig iron, such as NOLA (New Orleans). As mentioned, the interface screens can be configured to allow the transacting entities to view and the system 210, 310, 400 can be configured to store and utilize the contract size. In one embodiment the contract size is in metric tons, and in one very particular embodiment, the contract size is in increments of 20 metric tons.

The system 210, 310, 400 can also be configured to receive from a trading entity a delivery expiration parameter through one or more of the interface screens and store such parameter for use within the transaction. The delivery expiration can include when the pig iron needs to be delivered by or when the pig iron must be taken by, for the transaction.

In one embodiment, once the system 210, 310, 400, and processor therein, receives the pig iron market offers and one or more respective parameters associated therewith, as shown in blocks 422, 424, 432, and 434 of FIG. 4B, the system 210, 310, 400, and processor therein, is configured to determine whether the market buy/sell offer matches any pending sell/buy offers, respectively, as shown in blocks 426 and 436 of FIG. 4B. For example, the system 210, 310, 400 can be configured to allow buying and selling transacting entities to enter a price at which the buying and selling transacting entities wish to buy and sell, respectively, pig iron within the system 210, 310, 400 (or a derivative thereof). The system 210, 310, 400 will determine if any pig iron market offers to sell/buy are pending within the system 210, 310, 400 in order to determine if a match exists for such price parameter. If a match exists, the system 210, 310, 400 can be configured to execute or conclude a pig iron transaction for the matching buy and sell market offers, as indicated at block 428 and 438 of FIG. 4B. The system 210, 310, 400 can also be configured to create and store a record of the executed pig iron transaction in system memory for at least record keeping, reporting and archival. The system 210, 310, 400 can further be configured to communicate by email, or through some other communication medium, the executed pig iron transaction as well as all associated transaction details, including but not limited to all parameters of the pig iron transaction, as indicated at blocks 429 and 440 in FIG. 4B.

In one embodiment, the system 210, 310, 400 can be configured to require the trading entities to agree to adjusted payment terms when content levels of various components of the pig iron that has been purchased or sold are materially better than (greater than/less than minimum/maximum, respectively) predetermined parameters for such components of the pig iron. Specifically, when system 210, 310, 400 can be configured to implement, and require the trading entities to agree to, a delivery price adjustment formula, which shall apply to the actual price that is paid to the seller by the exchange when pig iron or a warrant therefore is being received by the exchange and/or the price that is being paid by the purchaser to the exchange when pig iron or a warrant therefore is being delivered to the purchaser of the pig iron. However, this actual price of the pig iron or pig iron contract may be different from the pig iron transaction for that pig iron contract that is actually executed by the system 210, 310, 400 when the system 210, 310, 400 actually matches buy and sell market offers, as described above at blocks 428 and 438 of FIG. 4B. In one embodiment, the system 210, 310, 400 can be configured to communicate adjustment formula interface screens to an exchange administrator client computer to allow an exchange administrator to enter and/or edit one or more adjustment formulas for storage within the system memory and retrieval and use by the system 210, 310, 400, as described herein. The adjustment formula interface screens can include input fields to receive and edit parameters and receive and edit mathematical connectors to establish and edit the formulas.

As a first example, the following sets forth a first delivery price adjustment formula which the system 210, 310, 400 can be configured to implement for actual payment upon delivery for the sale and/or purchase of the pig iron contract/warrant/pig iron. The first delivery price adjustment formula below adjusts the price of a specific lot(s) of pig iron for a pig iron transaction that has been already been executed on the pig iron market exchange computer system 210, 310, 400, described below. For example, if a lot has a higher percentage of iron than the minimum specified by the exchange for a deliverable contract, the formula below will correct or adjust the lot price for the value of the iron contained in that specific lot against the underlying exchange price for the pig iron transaction that has already been executed.

Pa=Pc+(((F−A)/(A+L))×Pc)

where
Pc=Contract Price, which is the price of the pig iron transaction executed within the pig iron market exchange computer system 210, 310, 400.
Pa=Adjusted Price, which is reflective of the actual value for a “lot” of the pig iron or other commodity with properties/chemistry superior to the minimum/maximum specified by the system 210, 310, 400, for the underlying pig iron or other commodity contract.
A=Threshold Chemical Requirement, which is a threshold for a specific element/component in an exchange traded commodity, such as pig iron.
F=Actual Iron contained in a specific lot(s) of a pig iron commodity.
L=Threshold of Materiality, which is used to allow for more/less adjustment when the superiority is more/less significant between the minimums/maximums as compared to the actual pig iron that has been sold and/or purchased.

The following sets forth an actual example showing the implementation of the first delivery price adjustment formula. In an exchange or pig iron market exchange computer system 210, 310, 400 that requires a minimum of 94% iron contained in the pig iron, and a seller delivers to the exchange pig iron with 96% iron contained in the pig iron, then the first delivery price adjustment formula will adjust the price for that lot to reflect its actual iron content as follows. For the purposes of this illustration, the price of the pig iron transaction that was executed on the exchange (Pc) is assumed to be $400 for 94% Fe material.

Pa=400+(((0.96−0.94)/(0.94+0))×400)

Thus, for this illustration, Pa=$408.51, which is $8.51 higher than the price of the pig iron transaction that was executed on the exchange, which compensates for the 2% higher iron content than the specifications or minimum iron content for the example exchange or pig iron market exchange computer system 210, 310, 400.

As a second example, the following sets forth a second delivery price adjustment formula which the system 210, 310, 400 can be configured to implement for actual payment upon delivery for the sale and/or purchase of the pig iron contract/warrant/pig iron. The second delivery price adjustment formula below also adjusts the price of a specific lot(s) of pig iron for a pig iron transaction that has been already been executed on the pig iron market exchange computer system 210, 310, 400, described below. For example, if a lot has a lower percentage of secondary elements or impurities than the maximum specified by the exchange for a deliverable contract, the formula below will correct or adjust the lot price to reflect the value of the lower contaminant level of that specific lot against the underlying exchange price.

Pa=Pc+(Pc×(Σ((EaΔAa)D/(Aa+(−L)))))

(from a=1 to n)

where:
Pc=Contract Price, which is the price of the pig iron transaction executed within the pig iron market exchange computer system 210, 310, 400.
Pa=Adjusted Price, which is reflective of the actual value for a “lot” of the pig iron or other commodity with properties/chemistry superior to the minimum/maximum specified by the system 210, 310, 400, for the underlying pig iron or other commodity contract.
Ea1 through Ean=Secondary Elements and/or Impurities present in a “lot” of a commodity. For pig iron, impurities may include, but are not limited to, S, Si, P, Mn, etc.
A=Threshold Chemical Requirement, which is a threshold for a specific element/component in an exchange traded commodity, such as pig iron.
D=Adjustment Factor, used to adjust the pricing more or less depending on how much the exchange or other controlling entity or authority determines that the pricing should be adjusted for each secondary element. D may be different for each secondary element present (Ea1 through Ean).
L=Threshold of Materiality, which is used to allow for more/less adjustment when the superiority is more/less significant between the minimums/maximums as compared to the actual pig iron that has been sold and/or purchased.
Δ is a difference function
Σ is a summation function, and in this formula the summation starts at a(1) and continues to a(n), where n is the number of different types of impurities or other factors that Pc is being adjusted for within the formula.

The following sets forth an actual example showing the implementation of the second delivery price adjustment formula. In an exchange or pig iron market exchange computer system 210, 310, 400 that requires a maximum of 0.05 for S (sulfer) and a maximum of 0.05 for P (phosphorus), and a seller delivers to the exchange pig iron with S content of 0.01 and P content of 0.02, then the second delivery price adjustment formula will adjust the price for that lot to reflect its actual S and P content as follows. For the purposes of this illustration, the price of the pig iron transaction that was executed on the exchange (Pc) is assumed to be $400 for 0.05 S content and 0.05 P content. In addition, this illustration assumes that the adjustment factor (D) for S (sulfur) is 0.00575 and the adjustment factor (D) for P (phosphorus) is 0.00275. Thus, in this illustration, n=2, as there are 2 different impurities that Pc is being adjusted to compensate for, as follows:

Pa=400+(400×({(0.01Δ0.05)0.00575/(0.05−(0))}+{(0.02Δ0.05)0.00275/(0.5(0))}))

Pa=400+(400×(0.00625))

Thus, for this illustration, Pa=$402.50, which is $2.50 higher than the price of the pig iron transaction (Pc) that was executed on the exchange, which compensates for the lower S and P impurity content than the specifications or maximum S and P content for the example exchange or pig iron market exchange computer system 210, 310, 400. It should be understood that the first and second adjustment formulas can be combined to both adjust for additional iron above the required specifications and to adjust for the smaller amount of impurities than the required specifications for the exchange traded pig iron verses the delivered pig iron. Thus, other adjustment formulas may be used to compensate for the various components of the delivered pig iron verses the specifications for the exchange traded pig iron.

As described, the system 210, 310, 400 requires the trading parties to (1) agree to the specifications (minimum content for certain components/maximum content for components or impurities) for the pig iron commodity being traded, which is significant in causing the pig iron to become a commodity and tradable on an open exchange, and (2) agree to the adjustment formula (s) for adjusting the price of the delivered pig iron to compensate for the various components of the delivered pig iron verses the specifications for the exchange traded pig iron. As such, referring to blocks 480 and 482 of FIG. 4C and/or to blocks 404 and 408 of FIG. 4A, the system 210, 310, 400 can be configured to provide and communicate information and terms to the client computer that the trading entity is using, including being bound to the specifications of the exchange regarding the component contents of the pig iron being traded on the exchange and/or being bound to one or more adjustment formulas of the exchange regarding the component contents of the actual pig iron that may be delivered as a result of a pig iron transaction on the exchange. The system 210, 310, 400 can also be configured to provide and communicate prompts to the client computer and receive inputs from such client computer that the trading entity user affirmatively agrees to specifications of the exchange regarding the component contents of the pig iron being traded on the exchange and/or agrees to one or more adjustment formulas of the exchange regarding the component contents of the actual pig iron that may be delivered as a result of a pig iron transaction on the exchange. The system 210, 310, 400 can further be configured to prevent access to functions within the system, such as those buy and/or sell functions provided through blocks 420-429 and/or 430-440, unless and until the system 210, 310, 400 receives such inputs from the trading entity user that the trading entity user affirmatively agrees to specifications of the exchange regarding the component contents of the pig iron being traded on the exchange and/or agrees to one or more adjustment formulas of the exchange regarding the component contents of the actual pig iron that may be delivered as a result of a pig iron transaction on the exchange. The system 210, 310, 400 is also configured to store in memory the agreement inputs received from the trading entity for documenting the agreement by the trading entity. Further, the exchange can provide to potential trading entities physical written (subscription) agreements and require that such potential trading entities agree in writing to the specifications of the components of the pig iron to be traded on the exchange and/or to one or more adjustment formulas for pig iron that is to be delivered as a result of a pig iron transaction on the exchange, prior to providing the potential trading entities access to the system 210, 310, 400.

In one embodiment, the system 210, 310, 400 can be further configured to receive pig iron component contents for specific lots of pig that will be delivered, such as the actual iron content and the content of impurities within the pig iron within the specific lots. Specifically, referring to blocks 432, 434, 480, 482, the system 210, 310, 400 can be configured to receive pig iron component contents for specific lots of pig iron, as a result of inputs into a seller trading entity client interface screen from a seller trading entity and/or as a result of inputs into an administrator interface screen from an exchange administrator. The system 210, 310, 400 can further be configured to store and track the component contents of specific lots of pig iron, and provide such component content information to purchasers and other system users upon request from and through pig iron lot(s) component content interface screens on client computers. In one embodiment, pig iron lots, and the component content information, are searchable by lot number, by seller identification and/or by other parameters.

Traditionally, prior to delivery of one or more lots of pig iron, the pig iron lots are tested by the seller and the pig iron component content information, weight and/or other information is made available to potential purchasers when offering the pig iron for sale in direct party to party sale of pig iron. In addition, independent third party testing companies have provided services of testing lots of pig iron to determine and provide such pig iron component content information, weight and/or other information to parties requesting testing and the provision of such information. In the present invention, the system 210, 310, 400 can also be configured to allow independent third party testing companies or users to establish a system tester account. The exchange would select one or more testers, and allow those testers to establish tester accounts within the system 210, 310, 400.

Once the tester accounts are established, the system 210, 310, 400 can be configured to allow trading entities or the exchange (when the exchange is the buying counterparty) to select one of the testers from within the system 210, 310, 400, to use to test actual lots of pig iron that are to be delivered as a result of a pig iron transaction on the system exchange. As a result of this selection by a trading entity or the exchange from within the system 210, 310, 400, the system 210, 310, 400 can be configured to electronically notify the selected independent third party tester that testing needs to be performed on specific lots of pig iron. For example, the system 210, 310, 400 can transmit an email communication to the third party tester, to an email address that was provided to the system 210, 310, 400 within the tester's account information, requesting the tester to perform testing on specific lots, which may include the location of the lots, the seller of the lots, the content of the components of each lot of pig iron to be tested that was provided by the seller, and other information needed to perform testing. The email communication could also be configured to provide a link for the tester to log into the system 210, 310, 400 under their account to view this same information. Other forms of notification to the tester including the information needed to perform testing could be provided as well.

Once the third party independent tester receives notification to perform testing of pig iron lots, the tester performs the testing and gathers the test results. Referring to block 490 of FIG. 4C, the system 210, 310, 400 is further configured to allow the third party tester to log into their account within the system through login interface screens and select to provide certification for the content of the components of one or more pig iron lots. At blocks 492, 494, and 496, the system 210, 310, 400 can be configured to transmit a component content test results interface screen to the client computer that the tester is using in order for the tester to select the pig iron lot that the tester tested, enter the component contents, and certify that the component contents that are stored within the system 210, 310, 400 are correct and/or that the component contents that the tester entered are correct. The system 210, 310, 400 can further be configured to then communicate the component contents and/or the results of the implenetation of one or more of the adjustment formulas, utilizing the certified component content information, to the counterparties for allowing the counterparties for make and receive payment of at least the adjusted price for the pig iron exchange transaction between those counterparties, which can also be carried out within the system 210, 310, 400.

In one embodiment, the system 210, 310, 400 can be configured as a pig iron market exchange computer system which lists the most recent pig iron market offer available for purchase, at all times during trading hours (which could be when the market is open and/or during “after-hours” trading as well). The pig iron market exchange computer system 210, 310, 400 can also be configured to list derivatives available for purchase or sale. The system 210, 310, 400 can configured to determine and/or calculate the pricing of the various listed pig iron derivatives, which will utilize and be related to the most recent pig iron market offer available for purchase. In one embodiment, the system 210, 310, 400 will be configured to determine or calculate the listed pig iron derivative prices utilizing and/or being related to a time factor and/or an interest rate. The time factor will typically be the date when the listed pig iron derivative is set to expire. In a further embodiment, the system 210, 310, 400 can be configured to determine or calculate a pig iron market index. The pig iron market index can be applied to facilitate trading of, for example, pig iron futures contracts.

User accounts can be limited to transactions below a predetermined monetary value, offer volume, or above or below a deal tenor limit. In one embodiment, these limits by the hosting entity of the system 210, 310, 400.

As indicted herein, all market activity and other system activity is tracked, starting with the transacting entity selecting a type of transaction and entering the necessary information to enter into a pig iron transaction, within the central database. The tracked information and actions can include all of the selected or entered information of each of the different users which participate in one way or another in entering into a pig iron market transaction, or only certain actions which the system is set up to track and store (if such action takes place). This information and actions include at least the actions of the transacting entity entering the parameters of a pig iron transaction set forth herein, including the terms of the pig iron transaction that is ultimately executed.

Referring to blocks 470 and 472, as indicated above, the system 210, 310, 400 has logic performing account maintenance functions, such as at least transaction entity user account creation and modification. As such, the system includes logic for communicating to an administrator user at a remote/client computer a plurality of user account information request prompts through an administrator interface screen, for establishing or modifying a user account. As mentioned herein, the prompts requesting the administrator to provide information to set up a user account can include input fields for entering an account name, a username, a login ID, a company name, an address, a phone number, an email address, financial limits per transaction, volume limits (minimum and/or maximum) per transaction. The system 210, 310, 400 have logic for providing prompts through at least an administrator interface for selecting and/or inputting this information and other information and limits for each user account. The system 210, 310, 400 also has logic for receiving the above and other user account and system information for establishing accounts and for establishing limits on how transaction processing proceeds. Specifically, user accounts can be limited to transactions below a predetermined monetary value, offer volume, or above or below a deal tenor limit. In one embodiment, these limits can be set by the hosting entity of the system 210, 310, 400. Thus, the system 210, 310, 400 includes logic for the server to receive all of the above administrator's responses to the prompts provided to the administrator requesting information, and to store all such information in the central database for use in transaction processing and for other purposes by the system 210, 310, 400.

Referring to FIG. 4A and blocks 416 and 418, as mentioned above, the system 210, 310, 400 further has logic for logic in the database for compiling summary information about user actions which have been stored in the central database, and logic for communicating the summary information to a user at a remote/client computer. The summary information can include details of each consummated transaction for each user, details of each buy offer, sell offer and other information communicated by a user, total transactions in a time period, total volume sold and/or bought over a time period, total price paid and or received over a time period, a break down of volume sold/purchased and/or dollars paid/received based on some criteria. Various other summaries and/or breakdowns of information come to mind based on the various criteria needed to establish a pig iron transaction according to the present description.

In one preferred embodiment of the present invention, the system 100, 200 is configured as an application service provider (ASP) exchange computer system, hosted by a host entity, as shown in FIG. 2 with the central computer 210 and central database 216, as well as pig iron market facilitator software application 310 and operating system 312 generally functioning as the ASP exchange computer system. In order to access the system, the host entity can provide a web link for the software application 310 to the user for use in accessing the system through a client device. The facilitator application 310 can be structured as separate applications, each performing separate, yet integrated, functions.

In another embodiment of the present invention, at least one portion of the system 100, 200 can implemented within the transacting party remote computers 120, 130, 140. Specifically, the transacting party remote computers 120, 130, 140 can include delivery “fat” client program code or application software for allowing the transacting parties to modify and/or confirm delivery parameters directly between the respective transacting party remote computers 120, 130, 140 for such transacting parties, such as on a “peer-to-peer” basis, instead of or in addition to the such functions being performed by the facilitator system 210, 310, 400. In this embodiment, the transacting party remote computers 120, 130, 140, that were used to enter into the transaction, and the delivery application code therein, also store the delivery parameters that were a part of transaction entered into between the transacting parties, including at least the delivery location, the delivery expiration, and/or the delivery price, for the pig iron transaction.

Once the transaction takes place, each of the transacting party remote computers 120, 130, 140 and the delivery application code therein, can be used to communicate within one another directly, within utilization of or having the communication take place through the central pig iron transaction facilitator computer 110. For example, if after entering into the transaction, one of the transacting parties requires delivery to another location, that transacting party can utilize the transacting party remote computers 120, 130, 140 and the delivery application code therein, to transmit a request to modify the location delivery parameter directly to the other transacting party remote computer 120, 130, 140 and the delivery application code therein, for consideration by the other transaction party. The transacting party remote computers 120, 130, 140 and the delivery application code therein can be configured to generate delivery parameter modification interface screens to allow the transacting entities to 1) view existing delivery parameters, 2) to enter revised delivery parameters, 3) to request that any revised delivery parameters be transmitted to the other transacting party to an entered into transaction, 4) to receive, view, accept, reject, and provide a counter-offer to received revised delivery parameters, and to perform other related functions. If the received delivery parameters will likely cause the costs to increase to the other transacting party receiving the revised delivery parameters, such as the delivery location being changed, then the other transacting party can select to reject the delivery parameter change request or enter a counter-offer into the interface screen where the revised delivery parameters are displayed within such interface screens. The interface screens can include one or more input fields to allow the other transacting party to enter the counter-offer, include a counter-offer on the price itself as a result of the request to change one or more delivery parameters. The other transacting party remote computer 120, 130, 140 and the delivery application code therein will then communicate the acceptance, rejection, and/or the counter-offer, such as a counter-offer in price or other delivery terms to first transacting party remote computer 120, 130, 140 and the delivery application code therein, for viewing, acceptance, rejection, or further counter-offering, to the initial counter-offer. The interface screens of the first transacting party remote computer 120, 130, 140 as generated by the delivery application code therein, display the counter-offer to the delivery parameters, and also provide input fields for acceptance, rejection, or further counter-offering to the initial counter-offer.

This back and forth process, including at least the requests for changes to the delivery parameters, counter-offers, acceptances, rejections, and/or other actions, is tracked and stored by each of the transacting party remote computers 120, 130, 140, and the delivery application code therein. From time to time, at either pre-scheduled intervals or in real time, each of the transacting party remote computers 120, 130, 140 and the delivery application code therein, will synchronize and transmit the above-mentioned tracking of the requests for change to delivery parameters, counter-offers, and other inputs and communications, to the central pig iron transaction facilitator computer 110, 210 and for storage and tracking within the associated central database 216, including any agreed upon changes to the delivery parameters, such as delivery location and/or price. As mentioned above, the delivery parameters which the transacting parties further negotiate directly between the respective transacting party remote computers 120, 130, 140, and the delivery application code therein, can include at least the delivery location, the delivery expiration, and the delivery price, for the pig iron. Also as mentioned above herein, the delivery location can include at least where pig iron may be picked up by the buying party, and the delivery expiration can include at least when the pig iron needs to be delivered by or when the pig iron must be taken by, for the transaction. Delivery price can include at least any of the pricing parameters disclose herein. Delivery parameters can also include any other parameters and/or arrangements needed for a pig iron contract, and settlement thereof, as one of ordinary skill in the art would understand. The transacting party remote computers 120, 130, 140, and the delivery application code therein, can also be configured to allow the respective transacting parties to achieve settlement and resolve any other settlement issues for a pig iron transaction, as one of ordinary skill in the art would understand. For example, or as an example of the present embodiment, if the tester described herein above provides results of the content of the components of the pig iron that are the subject of the entered into transaction, which are different than the content of the components as stated within the entered into transaction, then one of the transacting parties may wish to utilize a request to modify the delivery price in view of this difference of the content of the components. In such an example, the transacting party wishing to request a change in the delivery price could directly request a modification of the delivery price or could request that the above-identified formulas for variations in the content of the components which adjusts the price based on the content of the components be utilized for the requested change for the delivery price. As mentioned previously, the transacting parties may be bound to utilize such formulas for the delivery price when testers determine that the actual content of the component are different than the content of the components stated within the entered into transaction. The present embodiment may be utilized to provide a mechanism to modify the delivery price in such an example. Once the final delivery parameters are agreed upon or the transacting parties cannot agree on any modifications, based on the communications directly between the respective transacting party remote computers 120, 130, 140, and the delivery application code therein, then the latest form of the entered into pig iron transaction is then carried out by the transacting parties.

Any process descriptions or blocks in the figures, such as FIGS. 4A-4C and 44-46, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

What is claimed is:

1. A computer system for facilitating pig iron futures transactions, comprising:
a computer memory receiving and storing a first pig iron market offer and a second pig iron market offer, received from respective first and second transacting parties, each of the first and second market offers having at least one parameter associated therewith; and,
a processor for receiving the first and second pig iron market offers and respective at least one parameter associated therewith, wherein the processor is also provided for determining whether the first and second pig iron market offers stored in the computer memory match with one another, by at least determining whether the respective at least one parameter for each of the first and second pig iron market offer match, and wherein the processor is further provided for concluding a pig iron transaction when the first and second pig iron market offers match.

2. The computer system of claim 1 further comprising an exchange computer for listing the most current pig iron market offer(s) available for purchase and/or sale.

3. The computer system of claim 2 wherein the exchange computer also lists derivatives available for purchase and/or sale, the derivatives having a price related to the most recent pig iron market offer available for purchase.

4. The computer system of claim 3 wherein the processor calculates prices related the derivatives based on at least one of a time factor and an interest rate.

5. The computer system of claim 4 wherein the time factor is an expiration date for the derivative.

7. The computer system of claim 1 wherein the processor is further provided for deriving a pig iron market index and applying the index to facilitate trading of pig iron futures contracts.

8. The computer system of claim 2 wherein the exchange computer is configured for electronically transacting pig iron contracts.

9. The computer system of claim 1 wherein the at least one parameter comprises price, and wherein the system transmits information about other parameters, including at least one of: size of each piece in lot, chemistry specifications, delivery location, contract size, and/or delivery expiration.

10. The computer system of claim 9 wherein the size of each piece in lot ranges from 1 gram to 1000 kilograms per piece in the lot.

11. The computer system of claim 9 wherein the chemistry specifications comprise at least of one carbon content, silicon content, sulfur content, phosphorus content, manganese content, and/or iron content.

12. The computer system of claim 11 wherein the system is configured to transmit a agreement prompt requiring an actual or potential transacting party to agree to the chemistry specifications for pig iron trading.

13. The computer system of claim 11 wherein the system is configured to transmit an agreement prompt requiring an actual or potential transacting party to agree to implementation of an adjustment formula for adjusting the actual price of the pig iron transaction based on the tested content of at least one of the chemistry components of at least one lot to be delivered to fulfill the pig iron transaction.

14. The computer system of claim 11 wherein the system is configured to transmit information about the pig iron parameters, including that the pig iron carbon content is in the range of 0.5 to 10%, the silicon content is 5.0% or less, the sulfur content is 5% or less, the phosphorus content is 5% or less, the manganese content is 5% or less, and the iron content is at least 85%.

15. The computer system of claim 9 wherein the delivery location is at least one of Mobile, NOLA, Brussels, Seoul, Mumbai, Hong Kong, Taiwan, Rio, and/or PDM (Brazil).

16. The computer system of claim 9 wherein the contract size is the number of metric tons to enter into the transaction for.

17. The computer system of claim 14 wherein the contract size is only selectable in increments of a uniform quantity.

18. The computer system of claim 9 wherein the delivery expiration comprises one of when the pig iron needs to be delivered by or when the pig iron need to be taken by, or when the contract needs to be “closed out”.

19. The computer system of claim 1 wherein the system is configured to receive test results/certification of the content of at least one of the chemistry components of at least one pig iron lot to be delivered to fulfill a pig iron transaction.

20. The computer system of claim 1 wherein the system is configured to determine an adjusted price of at least one lot of pig iron to be delivered to fulfill a pig iron transaction utilizing an adjustment formula for calculating the adjusted price of the pig iron transaction based on the content of at least one of the chemistry components of at least of lot of pig iron.

21. The computer system of claim 20 wherein the system is configured to receive test results/certification of the content of at least one of the chemistry components of the at least one pig iron lot and utilize the test results within the adjustment formula to calculate the adjusted price.

22. The computer system of claim 1 further comprising:
a plurality of transacting party remote computers, each respective transacting party remote computer having delivery application code therein for allowing the transacting parties to negotiate final delivery parameters directly between the respective transacting party remote computers and delivery application code therein.

23. A computer readable medium for facilitating a pig iron commodity transaction, comprising:
logic for communicating a plurality of pig iron transaction prompts to the remote computer for entering a plurality of corresponding pig iron transaction parameters;
logic for receiving the plurality of entered pig iron transaction parameters in response to communicating the plurality of pig iron transaction prompts to the remote computer;
logic for determining whether the entered pig iron transaction parameters satisfy existing market pig iron transaction parameters; and,
logic for closing a transaction for pig iron if the entered pig iron transaction parameters satisfy existing market/exchange pig iron transaction parameters.

24. The computer readable medium of claim 23 further comprising:
logic for a communicating to a remote computer a plurality of user sign-in prompts for receiving sign-in responses;
logic for receiving the sign-in responses from the remote computer;
logic for determining whether a user is associated with the sign-in responses; and,
logic for verifying whether the user associated with the sign-in responses should be granted access to a plurality of market establishment prompts for establishing a market for the private commodity resource transaction.

25. The computer readable medium of claim 23 further comprising:
logic for a communicating to a remote computer a plurality of user account information request prompts for establishing a user account and for assigning system access-level and entitlements.

26. The computer readable medium of claim 23 wherein the plurality of pig iron transaction prompts are for entering transaction parameters for a pig iron buy transaction.

27. The computer readable medium of claim 23 wherein the plurality of pig iron transaction prompts are for entering transaction parameters for a pig iron sell transaction.

28. The computer readable medium of claim 23 wherein the plurality of pig iron transaction prompts are entering transaction parameters for a pig iron derivative transaction.

29. The computer readable medium of claim 23 wherein the pig iron transaction parameters comprise at least one of size of each piece in lot, chemistry specifications, delivery location, contract size, delivery expiration, and/or price.

30. The computer readable medium of claim 29 wherein the size of each piece in lot ranges from 1 gram to 1000 kilograms per piece in the lot.

31. The computer readable medium of claim 29 wherein the chemistry specifications comprise at least of one carbon content, silicon content, sulfur content, phosphorus content, manganese content, and/or iron content.

32. The computer readable medium of claim 31 wherein carbon content is in the range of 0.5 to 10%, the silicon content is 5.0% or less, the sulfur content is 5% or less, the phosphorus content is 5% or less, the manganese content is 5% or less, and the iron content is at least 85%.

33. The computer readable medium of claim 29 wherein the delivery expiration comprises one of when the pig iron needs to be delivered by or when the pig iron need to be taken by.

34. The computer readable medium of claim 29 wherein the price is in dollars per metric ton.

35. The computer readable medium of claim 23 further comprising:
logic for tracking and storing in memory each of the actions of the transacting party within the transaction process within a transaction history; and,
logic for recalling from memory the transaction history.

36. The computer readable medium of claim 35 further comprising:
logic for compiling summary information about the transacting party actions; and,
logic for communicating the summary information about the transacting party.

37. The computer readable medium of claim 23 further comprising:
logic for determining an adjusted price of at least one lot of pig iron to be delivered to fulfill a pig iron transaction utilizing an adjustment formula for calculating the adjusted price of the pig iron transaction based on the content of at least one of the chemistry components of the at least of lot of pig iron.

38. The computer readable medium of claim 37 further comprising:
logic for receiving test results of the content of at least one of the chemistry components of the at least one pig iron lot; and,
logic for utilizing the test results within the adjustment formula to calculate the adjusted price.

39. An exchange traded pig iron product contract established according to a trading method comprising the steps of:
receiving and storing a first pig iron market offer and a second pig iron market offer in a computer memory, received from respective first and second transacting parties, each of the first and second market offers having at least one parameter associated therewith; and,
receiving the first and second pig iron market offers and respective at least one parameter associated therewith at a processor, wherein the processor is also determines whether the first and second pig iron market offers stored in the computer memory match with one another, by at least determining whether the respective at least one parameter for each of the first and second pig iron market offer match, and wherein the processor concludes a pig iron transaction to establish the exchange traded pig iron product contract when the first and second pig iron market offers match.
